(19) United States
(12) Patent Application Publication
(10) Pub. No.: US 2005/0118307 A1
(43) Pub. Date: Jun. 2, 2005

(54) Frozen or chilled and linked jiaozis with emulsified batter

(75) Inventors: Junko Gonda, Oura-gun (JP); Keisuke Imaizumi, Oura-gun (JP); Yoshiyuki Shimizu, Oura-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO. INC, Tokyo (JP)

(21) Appl. No.: 10/981,664

(22) Filed: Nov. 5, 2004

(30) Foreign Application Priority Data
Nov. 7, 2003 (JP) 2003-378546

(51) Int. Cl. A23G 1/00

(52) U.S. Cl. 426/100

(57) ABSTRACT

To provide jiaozis allowing respective jiaozis to be prevented from shifting from the arranged position in the tray during transit and being capable of readily carrying out the large scale cooking at a time in a short period of time, as well as improving the appearance by providing burrs at the periphery of the jiaozis, and achieving a favorable texture are provided. Frozen or chilled and linked jiaozis (dumpling stuffed with minced meat) with a batter, which are characterized in that: a butter containing water, an oil or oils, an emulsifier or emulsifier, a starch or starches and a protein or proteins in a specified composition, which is substantially free of cereal flour is emulsified; and the batter in the emulsified state and two or more jiaozis are arranged in a tray such that the fried surface of the jiaozis is positioned on the side of the batter and that the two or more jiaozis are linked and fixed via the batter.

### CROSS REFERENCES TO RELATED APPLICATIONS

This application claims priority to Japanese Patent Application No. 378546/2003, filed on Nov. 7, 2003, which is incorporated herein by reference in its entirety.

### BACKGROUND OF THE INVENTION

### FIELD OF THE INVENTION

The present invention relates to frozen or chilled and linked jiaozis. The present invention further relates to frozen or chilled, linked jiaozis which retain a crispy texture when cooked. The present invention also relates to methods for making such frozen or chilled, linked jiaozis.

### DISCUSSION OF THE BACKGROUND

Generally, in the cooking of fried jiaozis, fresh or steamed jiaozis, or frozen ones thereof as the case may be, are put on an iron plate pan oiled on the entire face and then smothered (steamed/roasted or baked in a casserole).

However, in this process, the number of pieces which can be cooked at one time is naturally limited. Thus, such a process is disadvantageous in that: (1) large scale cooking in a short period of time is difficult; (2) frying takes a lot of trouble; and (3) a degree of skill is required for providing a well-looking browned pattern.

Moreover, in the cooking of jiaozis, it has been known to add a solution which contains suspended wheat flour to the frying pan during the smothering (steaming/roasting or baking in a casserole) of the jiaozis so as to provide burrs (the state in which a thinly spread batter is heated well, is solidified, and takes on a crispy state on the surface) at the periphery of the jiaozi to improve the appearance thereof, and to achieve a favorable texture. However, to provide the burrs at the periphery of the jiaozis properly in such a manner requires a considerable amount of skill.

In addition, there exist frozen jiaozis which are on the market in the form of being packed in a bag provided after placing respective jiaozis in a tray or the like. However, such frozen jiaozis in a bag provided after placing respective jiaozis in a tray or the like may be potentially shifted from the arranged position of the respective jiaozis in the tray during transit. When the jiaozis are shifted from the arranged position, the appearance may be poor for selling, and thus, the jiaozis may need to be rearranged to improve the appearance at the time of sale.

Moreover, in the case of fried jiaozis taken “to go” from a restaurant, a long time of period passes between the finishing of the frying until eating, and, therefore, the fried surface becomes sodden (soggy), resulting in not only a bad appearance, but also a marked loss of crispy texture of fresh frying, and fragrant flavor.

Accordingly, a process for producing frozen fried jiaozis which can be cooked readily on a large scale, which enables the improvement of the texture of the fried surface, the appearance, and the flavor, while achieving a homogenously fried color on the fried surface and having a texture that is approximate to the freshly fried state as well as a fragrant flavor after cooking, by frying after applying an emulsion having a specified composition to the bottom face of the jiaozis has been proposed (see, JP-A-6-245740).

According to this process, a freshly-fried texture is imparted to the fried surface by frying after applying an emulsion containing water, an oil or oils, an emulsifier or emulsifiers, a cereal flour or cereal flours (including a starch), and/or a protein or proteins to the surface to be fried of the jiaozi.

However, there is no disclosure in JP-A-6-245740 in connection with the settlement or shifting of respective jiaozis during transit through linking and fixing a plurality of jiaozis, or with the improvement of the appearance and texture of the jiaozis and burrs upon eating. Additionally, when this process is carried out in practice, the batter may not be sufficiently frozen in some cases, therefore, the jiaozis then can not be drawn from the tray prior to cooking in the linked state. Furthermore, this process may not produce burrs with a crispy feel, because the batter spreads to give a film which is too thin when they are fried.

A process in which the scattering or shifting of respective frozen jiaozis on a tray during transit or handling is prevented by freezing a linking material set in such a fashion as to encircle the side faces of the respective jiaozis has also been proposed (see, JP-A-2003-000204). However, because a cereal flour is involved as an essential component in this process, it is hard to alter the amount of the added starch and protein ad libitum which may be included in the cereal flour, and the influence of a minor constituent such as cellulose is not negligible. Accordingly, it is difficult to adjust a variety of characteristics of the burrs by combining different properties carried by the starch and protein. In addition, the means for sufficiently forming burrs without adding any emulsifier is limited to only the reduction of the viscosity by decreasing the solid content. In this instance, the disadvantages of not forming a sufficient amount of burrs having a feeling of body that imparts a crispy feel, thereby not imparting a preferable texture arise. Furthermore, this process is not preferred in terms of the necessity of separately oiling upon cooking of the jiaozis. However, no solution for these problems is described or suggested.

Further, a process for linking jiaozis by providing thick liquid housing parts in the bottom of the tray for placing the jiaozis, and using a batter has been proposed (see, JP-A-11-056313). However, this process is not preferred in terms of the high cost due to the complicated shape of the tray. Additionally, similarly to the case of JP-A-2003-000204, when an emulsifier and an oil are not included in the batter, a sufficient amount of burrs capable of imparting a crispy feel is not formed, and the jiaozis can not be fried without use of an oil. However, no solution for solving these problems is described or suggested.

Thus, there remains a need for frozen or chilled jiaozis which provide a crispy surface when cooked. There also remains a need for a tray of frozen or chilled jiaozis in which the jiaozi do not shift during transport.

### SUMMARY OF THE INVENTION

Accordingly, it is one object of the present invention to provide novel frozen or chilled jiaozis.

It is another object of the present invention to provide novel frozen or chilled jiaozis which exhibit a crispy texture with crispy burrs on the surface when cooked.

It is another object of the present invention to provide a plurality of frozen or chilled jiaozis which are linked such that their relative positions do not shift during transport.

It is another object of the present invention to provide novel methods for making such frozen or chilled jiaozis.

Thus, the present invention provides a plurality of jiaozis in which the respective jiaozis show a reduced tendency to shift from the arranged position in a tray during transit and which are suitable for readily carrying out large scale cooking at a time in a short period of time, as well as improving the appearance by providing burrs at the periphery of the jiaozis, and achieving a favorable texture.

These and other objects, which will become apparent during the following detailed description, have been achieved by the inventors' discovery of frozen or chilled and jiaozis which are linked with a batter, in which the batter is an emulsified batter comprising:
(a) water;
(b) one or more oils,
(c) one or more emulsifiers;
(d) one or more starches; and
(f) one or more proteins in a specified composition,
   in which the batter is substantially free of cereal flour;
   where the batter and a plurality of jiaozis are arranged in a tray such that the surface which is already fried or to be fried of the jiaozis is positioned on the side of the batter and that at least two or more jiaozis are linked and fixed via the batter.

Thus, the present invention provides the following:
1. Frozen or chilled jiaozis linked with a batter, wherein said batter is an emulsified batter which comprises:
(a) 50 to 80 wt. % of water;
(b) 5 to 30 wt. % of one or more oils;
(c) 0.6 to 8 wt. % of one or more emulsifiers;
(d) 6 to 10 wt. % of one or more starches; and
(e) 0.1 to 0.7 wt. % of one or more proteins,
   provided that the batter is substantially free of cereal flour, in which batter is in an emulsified state and two or more jiaozis are arranged in a tray such that the surface which is already fried or to be fried of the jiaozis is positioned on the side of the batter and that the two or more jiaozis are linked and fixed via the batter.
2. The frozen or chilled jiaozis linked with a batter according to the above item (1) in which the average thickness of the batter that links and fixes the jiaozis is 1 mm or more, and is equal to or less than half of the height of the jiaozi.
3. The frozen or chilled jiaozis linked with a batter according to the above item (1) or (2) in which the batter and two or more jiaozis are arranged in a tray after providing the jiaozi with a fried surface.
4. A method for making frozen or chilled jiaozis linked with a batter, said method comprising:
(1) emulsifying a batter, wherein said batter comprises:
(a) 50 to 80 wt. % of water;
(b) 5 to 30 wt. % of one or more oils;
(c) 0.6 to 8 wt. % of one or more emulsifiers;
(d) 6 to 10 wt. % of one or more starches;
(e) 0.1 to 0.7 wt. % of one or more proteins
   provided that the batter is substantially free of cereal flour;
(2) arranging the batter in an emulsified state and two or more jiaozis in a tray such that the surface which is already fried or to be fried of the jiaozis is positioned on the side of the batter and that the two or more jiaozis are linked and fixed via the batter.

Through the utilization of the present invention, a plurality of jiaozis, in which the respective jiaozis are prevented from shifting from the arranged position in the tray during transit, and which are suitable for readily carrying out the large scale cooking at a time in a short period of time, and afford an improved appearance by providing burrs at the periphery of the jiaozis, and provide a favorable texture can be provided.

### DETAILED DESCRIPTION OF THE PREFERRED EMBODIMENTS

Thus, in a first embodiment, the present invention provides novel frozen or chilled jiaozis linked with a batter, wherein said batter is an emulsified batter which comprises:
(a) 50 to 80 wt. % of water;
(b) 5 to 30 wt. % of one or more oils;
(c) 0.6 to 8 wt. % of one or more emulsifiers;
(d) 6 to 10 wt. % of one or more starches; and
(e) 0.1 to 0.7 wt. % of one or more proteins,
   provided that the batter is substantially free of cereal flour, in which the batter is in an emulsified state and two or more jiaozis are arranged in a tray such that the surface which is already fried or to be fried of the jiaozis is positioned on the side of the batter and that the two or more jiaozis are linked and fixed via the batter.

The jiaozis referred to herein is not particularly limited, but are preferably raw ones which contain ingredients wrapped in a dough sheet, ones which have already been subjected to heat cooking such as steaming, or ones which have been subjected to freezing or chilling during these steps, irrespective of the shape and cooking process of the jiaozi per se. Also, the process for producing the jiaozi referred to herein is not particularly limited, but any of known processes to persons skilled in the art may be employed for producing the ingredients and dough sheet.

According to the present invention, the number of frozen or chilled jiaozis to be linked and fixed via an emulsified batter is two or more. When the number of jiaozis is one, the problem involving the linkage of the jiaozis to one another does not exist. Moreover, the upper limit of the number of the jiaozis to be linked may be selected ad libitum depending on the size and mode of utilization of the jiaozi. Too large a number of jiaozis is not preferred because it may be difficult to take them out from a bag and set them on a frying pan all at a time, and handling during cooking may involve difficulty. Conveniently, the upper limit for the number of jiaozis which are linked may be selected to be 144, 100, 50,25, 15, 10, 8, 6, or 4.

It is important that the water for use in the batter according to the present invention is included in the batter in an amount of 50 to 80 wt. %, and preferably 65 to 77 wt. %, based on the total weight of the batter as prepared.

It is important that the oil for use in the batter according to the present invention is included in the batter in an amount of 5 to 30 wt. %, preferably 10 to 30 wt. %, and more preferably 15 to 25 wt. %, based on the total weight of the batter as prepared. The kind of the oil is not particularly limited as long as it is edible, and the physical state of the oil at room temperature may be either liquid or solid. Examples of suitable oils include rapeseed oil, soybean oil, corn oil, safflower oil, palm oil, lard, shortening, butter, sesame oil, olive oil, and the like, and mixtures thereof.

It is important that the emulsifier for use in the batter according to the present invention is included in the batter in an amount of 0.6 to 8 wt. %, preferably 1 to 4 wt. %, and more preferably 1 to 3 wt. %. based on the total weight of the batter as prepared. The kind of the emulsifier is not particularly limited as long as it is edible. Examples of suitable emulsifiers include lecithins (derived from soybean, derived from egg, and the like), enzyme-digested lecithins, sugar esters, monoglycerides, polyglycerol fatty acid esters, propylene glycol fatty acid esters, and the like, and mixtures thereof.

It is important that the starch for use in the batter according to the present invention is included in the batter in an amount of 6 to 10 wt. %, and preferably 6.5 to 8.5 wt. %, based on the total weight of the batter as prepared. The kind of the starch is not particularly limited as long as it is edible. Examples of suitable starches include rice starch, waxy rice starch, wheat starch, corn starch, waxy corn starch, tapioca starch, sago palm starch, mung bean starch, potato starch, sweet potato starch, and the like, and mixtures thereof.

It is important that the protein for use in the batter according to the present invention is included in the batter in an amount of 0.1 to 0.7 wt. %, preferably 0.2 to 0.6 wt. %, based on the total weight of the batter as prepared. The kind of the protein is not particularly limited as long as it is edible. Examples of the protein include egg albumen powder, separated soybean protein, powdered skimmed milk, powdery wheat protein, whole egg powder, and the like, and mixtures thereof. Among them, egg albumen powder is particularly preferred in light of the flavor.

The batter is substantially free of any cereal flour. In the context of the present invention the term “substantially free of any cereal flour means that the batter comprises less than 1 wt. %, preferably less than 0.1 wt. %, more preferably less than 0.01 wt. %, of cereal flour. In a particularly preferred embodiment, the batter does not contain any cereal flour.

In the context of the present invention, the term “cereal flour” specifically means wheat flour, rice flour, corn flour, barley flour, buckwheat flour, potato flour, soybean flour, adzuki flour, barnyard millet flour, chestnut flour, millet flour or the like, which is a flour obtained by merely grinding a cereal grain. When a cereal flour is used, it is hard to alter ad libitum the amount of the added starch and protein included in the cereal flour, and the influence of a minor constituent such as cellulose is not negligible. Accordingly, it is not preferred due to difficulties in adjusting characteristics of the burr in various aspects by combining different properties carried by the starch and protein.

The batter may further comprise a seasoning. The seasoning for use in the batter according to the present invention is not particularly limited. Accordingly, soy sauce, salts, amino acids and the like may be added. Moreover, gums, celluloses and the like may be added thereto for the purpose of adjusting the viscosity and adjusting the texture as long as it is a material other than the cereal flour.

In the context of the present invention the term “frozen” means to be in the condition of having a temperature of −5° C. or less. In light of preventing deterioration in quality, a freezing temperature of −18° C. or less is preferred. The freezing temperature is usually in the range of from −45 to −5° C., although it also depends on the performance of the freezer. It is also important that the batter is frozen (i.e., in a solid, not liquid, form) at the freezing temperature for the practice of the present invention.

The present invention is also characterized in that the batter is emulsified. By emulsifying the batter, characteristics of the batter may be homogenous, thereby permitting to impart a homogenous and preferable texture and appearance to the jiaozis.

According to the present invention, it is preferred that the average thickness of the batter that links and fixes the jiaozis is 1 mm or more, and is equal to or less than half of the height of the jiaozi, because the average thickness of the batter of 1 mm or more is required for stably fixing a plurality of jiaozis, while the thickness of equal to or less than half of the height of the jiaozi is desired for achieving the preferred shape of the burr and texture. Typically, the height of the jiaozi is from 1 to 10 cm, more typically 2 to 5 cm.

The preferred shape of the burr in the present invention is in a sufficiently spread state to give a thin film. Moreover, the preferred texture of the burr in the invention is a texture having an enough feel of body and crispy feel.

According to the present invention, the shape of the tray is not particularly limited, but it is desirably in a simple shape in light of the cost, and is preferably in a shape having a flat bottom face.

Other features of the invention will become apparent in the course of the following descriptions of exemplary embodiments which are given for illustration of the invention and are not intended to be limiting thereof.

### EXAMPLES

In the following examples, “%” in the description means “% by weight” unless specifically stated.

Production of a Batter as a Control.

The composition of a control batter is: 25% of the oil (manufactured by Ajinomoto Seiyu Co., Inc., “rapeseed (canola) oil”), 2% of the emulsifier (manufactured by Ajinomoto Seiyu Co., Inc., soybean lecithin), 8% of the starch (wheat starch) and 0.4% of the protein (egg albumen powder) per 64.6% of water.

Using this control batter composition, a mixture except for the oil and emulsifier was added to water, which was stirred with a Barmix for 5 min while gradually adding the oil in which the emulsifier is fused to produce a batter. In each Example, when the amount of the added material is altered, the varied part was compensated for by adjusting the amount of water such that the total of the % values remained 100%.

In the invention, sensory evaluation was conducted as follows. Specifically, five jiaozis (“GYOZA”, manufactured by AJINOMOTO FROZEN FOODS Co., Inc.) were arranged in a tray having a flat inner bottom face such that the surface to be fried of each jiaozi rests on the flat inner bottom face of the tray. A batter of each Example was filled to give the average thickness of 0.5 cm, followed by sufficient freezing with a quick freezing machine at −35° C. to provide a sample. The solidification of the batter during the freezing links the jiaozi. When the Example is carried out, the linked jiaozis were drawn from the tray together with the batter, and were subjected to heat cooking by smothering for 5 min in a frying pan having a diameter of 26 cm on medium heat. The values for use in the sensory evaluation were based on linkage property, viscosity of the batter, formation degree of the burrs, texture, appearance, and overall points. The state of formation of the burrs for use was based on the value when a frying pan having a diameter of 26 cm was used. As the values of the sensory evaluation, mean values from evaluation by five persons in charge were used.

The scoring was as follows:

Linkage property:
−2=soft
0=C, intermediate
+2=hard

Viscosity:
−2=low
0=C, intermediate
+2=high

Formation of burr:
−2=small
0=C, intermediate
+2=great

Texture:
−2=bad
0=C, intermediate
+2=good

Spread of batter:
−2=bad
0=C, intermediate
+2=good

Appearance:
−2=bad
0=C, intermediate
+2=good

### Example 1

### Influence of the Ratio of Emulsifier on the Linkage Property of the Jiaozis and the Formation of Burrs

Although the amount of the emulsifier in the control batter was 2%, the sensory evaluation was conducted while changing the content of the emulsifier to 0%, 1%, 2%, 4%, and 10%. The results are shown in Table 1.

TABLE 1

| | Linkage | | | | Spread of | |
|---|---|---|---|---|---|---|
| | property | Viscosity | Formation | Texture | batter | |
| | −2 to 0 to | −2 to 0 to | of burr | −2 to 0 to | −2 to 0 to | Appearance |
| | +2 | +2 | −2 to 0 to +2 | +2 | +2 | −2 to 0 to +2 |
| Content of | soft to C | low to C | small to C | bad to C | bad to C | bad to C to |
| emulsifier | to hard | to high | to great | to good | to good | good |
| 0% | 0 | −2 | 0 | −2 | −1.5 | −2 |
| 1% | 0 | 0 | 0 | 0 | 0 | 1 |
| 2% | 0 | 0 | 1 | 0 | 2 | 2 |
| 4% | 0 | 0.5 | 1 | −0.5 | 2 | −2 |
| 10% | 0 | 1.5 | 1 | −1 | 2 | −2 |

From the results shown in Table 1, it is seen that the degree of formation of the burrs is low when the amount of the emulsifier is 1%. By adding the emulsifier in an amount of 2% to 10%, the batter sufficiently spreads, thereby enabling the formation of the burrs having a preferable texture. When the amount of the added emulsifier is 0.5% or less, it was not preferred because the batter did not spread well, and thus sufficient burrs could not be produced. To the contrary, when the amount as added was 4% or more, it was not preferred because a large amount of fat and oil remained on the frying pan after frying. According to this Example, the optimal amount of the added emulsifier was 2%. Furthermore, any one of gums and proteins may be added as an emulsion stabilizer.

### Example 2

### Influence of the Ratio of Oil on the Linkage Property of the Jiaozis and the Formation of Burrs

Although the amount of the oil in the control batter was 25%, the sensory evaluation was conducted while changing the content of the oil to 0%, 10%, 15%, 20%, 25%, and 30%. The results are shown in Table 2.

TABLE 2

| | Linkage | | Formation | | Spread of | |
|---|---|---|---|---|---|---|
| | property | | of burr | Texture | batter | Appearance |
| | −2 to 0 to | Viscosity | −2 to 0 to | −2 to 0 to | −2 to 0 to | −2 to 0 to |
| | +2 | −2 to 0 to +2 | +2 | +2 | +2 | +2 |
| Content | soft to C | low to C to | small to C | bad to C | bad to C to | bad to C to |
| of oil | to hard | high | to great | to good | good | good |
| 0% | 2 | −2 | −1 | −1.5 | 0 | −2 |
| 10% | 1 | −1 | 0 | −0.5 | 0.5 | 2 |
| 15% | 1 | −1 | 0 | 0 | 0 | 1 |
| 20% | 0.5 | −0.5 | 0 | 0 | 0 | −0.5 |
| 30% | 0 | 0 | 0 | 0 | 0 | −2 |

From the results shown in Table 2, it was revealed that an oil content of 0% resulted in heterogeneous fried color, thereby providing unpreferable appearance. To the contrary, when the oil content was 30% or more, it was not preferred because a large amount of oil remained on the frying pan after frying, and also, the oily feel of the burr was increased. From a comprehensive decision, it is preferred that the oil content is 15 to 25%.

### Example 3

### Influence of the Ratio of the Starch on the Linkage Property of the Jiaozis and the Formation of Burrs

Although the amount of the starch in the control batter was 8%, the sensory evaluation was conducted while changing the amount of the starch to 0.0%, 3.2%, 6.5%, 8.0%, and 9.0%. The results are shown in Table 3.

TABLE 3

| | Linkage | | | | Spread of | |
|---|---|---|---|---|---|---|
| | property | Viscosity | Formation | Texture | batter | |
| | −2 to 0 to | −2 to 0 to | of burr | −2 to 0 | −2 to 0 to | Appearance |
| | +2 | +2 | −2 to 0 to +2 | to +2 | +2 | −2 to 0 to +2 |
| Content | soft to C | low to C | small to C | bad to C | bad to C | bad to C to |
| of starch | to hard | to high | to great | to good | to good | good |
| 0.0% | 2 | −2 | −2 | −2 | 2 | −2 |
| 3.2% | 0 | 0 | 0 | 0 | 0 | 0 |
| 6.5% | −0.5 | 0 | 1 | −0.5 | −0.5 | 1 |
| 8.0% | −0.5 | 1 | 1 | −0.5 | −0.5 | 1 |
| 9.0% | −2 | 2 | −2 | −2 | −2 | −2 |

From the results shown in Table 3, it is seen that less starch is more preferred in light of the linkage property of a plurality of jiaozis, however, without inclusion of 3% or more of starch, the thus-produced burr is free from a feel of body, thereby resulting in difference in imparting the crispness. Moreover, when the amount of the starch is 9% or more to the contrary, it was difficult to produce sufficient burrs because the viscosity becomes too high, thereby resulting in deteriorated spreading capability of the batter. When viewed comprehensively, the content of 6.5% and 8% was most preferable.

### Example 4

### Influence of Kind of Starch on the Linkage Property of the Jiaozis and the Formation of Burrs

With the amount of the starch of 8% in the control batter unchanged, the identity of the starch was changed to ordinary rice starch (manufactured by Shimada Kagaku Kogyo KK), waxy rice starch (manufactured by Shimada Kagaku Kogyo KK), wheat starch (manufactured by GLICO FOODS CO.,LTD.), corn starch (manufactured by NIHON SHOKUHIN KAKO CO., LTD), waxy corn starch (manufactured by NIHON SHOKUHIN KAKO CO., LTD), tapioca starch (manufactured by NIHON SHOKUHIN KAKO CO., LTD), sago pahn starch (manufactured by Tokai Denpun Co., LTD.), mung bean starch (manufactured by NIPPON STARCH CHEMICAL CO.,LTD.), potato starch (manufactured by Minami Tokachi Nousan Kakou Nougyou Kyoudou Rengou Kai) or sweet potato starch (manufactured by Tokai Denpun Co., LTD.), and the sensory evaluation was conducted with the batter of joshinko (a kind of rice flour) as a control. The results are shown in Table 4.

TABLE 4

| | Linkage | Viscosity | Formation of | Texture | |
|---|---|---|---|---|---|
| | property | −2 to 0 to | burr | −2 to 0 to | Appearance |
| | −2 to 0 to +2 | +2 | −2 to 0 to +2 | +2 | −2 to 0 to +2 |
| Kind of | soft to C to | low to C to | small to C to | bad to C to | bad to C to |
| Starch | hard | high | great | good | good |
| ordinary rice | 0 | 0 | 0 | 0 | 0 |
| starch | | | | | |
| waxy rice | 0 | 0 | 1 | 1 | 2 |
| starch | | | | | |
| wheat starch | −1 | 0 | 2 | −2 | 1 |
| corn starch | 0.5 | 1 | 1 | −1 | 0 |
| waxy corn | −0.5 | −2 | 1 | 0 | 0 |
| starch | | | | | |
| tapioca starch | 0.5 | −1.5 | −1 | −1 | 1 |
| sago palm starch | −0.5 | −1.5 | 0 | 1 | 2 |
| mung bean | 0 | −1.5 | −1 | −1 | 1 |
| starch | | | | | |
| potato starch | −1 | 2 | −1.5 | −1.5 | 2 |
| sweet potato | −1 | 1 | −0.5 | 0 | 1 |
| starch | | | | | |

*Control (C): joshinko batter

From the results shown in Table 4, it is seen that each of the starches tested exhibited favorable results from a comprehensive standpoint, although the characteristics of the batter varied depending on the kind of the starch. Among them, waxy rice starch and sago palm starch were particularly characterized by imparting a crispy and favorable texture, and preferable appearance, whilst wheat starch was characterized by formation of a lot of burrs. Accordingly, it was revealed that the starch can be selected to serve the purpose of the intended jiaozi.

### Example 5

### Influence of the Ratio of the Protein on the Linkage Property of the Jiaozis and the Formation of Burrs

Although the amount of the protein in the control batter was 0.4%, the sensory evaluation was conducted while changing the amount of the protein to 0.0%, 0.2%, 0.4%, and 0.8%. The results are shown in Table 5.

TABLE 5

| | Linkage | | Formation | | Spread of | |
|---|---|---|---|---|---|---|
| | property | | of burr | | batter | Appearance |
| | −2 to 0 to | Viscosity | −2 to 0 to | Texture | −2 to 0 to | −2 to 0 to |
| Content | +2 | −2 to 0 to +2 | +2 | −2 to 0 to +2 | +2 | +2 |
| of | soft to C | low to C to | small to C | bad to C to | bad to C | bad to C to |
| protein | to hard | high | to great | good | to good | good |
| 0.0% | 0 | −2 | −2 | −2 | −2 | −2 |
| 0.2% | 0 | 0 | 0 | 0 | 0 | 0 |
| 0.4% | 0 | 0 | 1 | 0 | −0.5 | 1 |
| 0.8% | 0 | 1 | −1 | −0.5 | −1 | −2 |

From the results shown in Table 5, it is seen that a protein content of 0% resulted in difficulty in producing preferable burrs. To the contrary, a protein content of 0.8% was not preferred because the viscosity of the batter became too high.

### Example 6

### Influence of the Kind of Protein on the Linkage Property of the Jiaozis and the Formation of Burrs

With the amount of the protein of 0.4% in the control batter unchanged, a kind of starch was changed to egg albumen powder(manufactured by EUROVO), separated soybean protein (manufactured by Ajinomoto Co., Inc.), powdered skimmed milk (manufactured by YOTSUBA Inc.), powdery wheat protein (manufactured by GLICO FOODS CO.,LTD.) or whole egg powder (manufactured by Taiyo Kagaku Co., Ltd.), and the sensory evaluation was conducted. The results are shown in Table 6.

TABLE 6

| | Linkage | | Formation | | Spread of | |
|---|---|---|---|---|---|---|
| | property | Viscosity | of burr | Texture | batter | |
| | −2 to 0 to | −2 to 0 to | −2 to 0 to | −2 to 0 to | −2 to 0 to | Appearance |
| | +2 | +2 | +2 | +2 | +2 | −2 to 0 to +2 |
| Kind of | soft to C to | low to C | small to C | bad to C | bad to C | bad to C to |
| Protein | hard | to high | to great | to good | to good | good |
| egg | 0 | 0 | 0 | 0 | 0 | 0 |
| albumen | | | | | | |
| powder | | | | | | |
| separated | 0 | 0 | 0 | −1 | 0 | −0.5 |
| soybean | | | | | | |
| protein | | | | | | |
| powdered | 0 | 0 | 0 | 0 | 0 | 0 |
| skimmed | | | | | | |
| milk | | | | | | |
| powdery | 0 | 0 | 0 | 0 | 0 | 0 |
| wheat | | | | | | |
| protein | | | | | | |
| whole egg | 0 | 0 | 0 | 0 | 0 | 1 |
| powder | | | | | | |

From the results shown in Table 6, it I seen that each protein tested was equally efficacious, however, egg albumen powder was preferred among them in light of the flavor.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. Two or more frozen or chilled jiaozis, wherein said jiaozis have a surface which is already fried or to be fried and are linked with a batter, and said batter is an emulsified batter comprising:
(a) 50 to 80 wt. %, based on the total weight of said batter, of water;
(b) 5 to 30 wt. %, based on the total weight of said batter, of one or more oils;
(c) 0.6 to 8 wt. %, based on the total weight of said batter, of one or more emulsifiers;
(d) 6 to 10 wt. %, based on the total weight of said batter, of one or more starches; and
(e) 0.1 to 0.7 wt. %, based on the total weight of said batter, of one or more proteins,
provided said batter is substantially free of cereal flour,
wherein said two or more jiaozis are arranged in a tray with an inner, upward-facing, bottom surface such that said surface which is already fried or to be fried of said two or more jiaozis is positioned downward toward said inner, upward-facing, bottom surface of said tray and a layer of said batter is present on said inner, upward-facing, bottom surface between said two or more jiaozis and said two or more jiaozis are linked by said batter.

2. The frozen or chilled jiaozis of claim 1, wherein said layer of said batter has an average thickness of from 1 mm to less than half of the height of said jiaozi.

3. The frozen or chilled jiaozis of claim 1, wherein said batter and said two or more jiaozis are arranged in said tray after providing said two or more jiaozi with a surface which has already been fried.

4. The frozen of chilled jiaozis of claim 1, wherein said batter comprises water in an amount of 65 to 77 wt. %, based on the total weight of said batter.

5. The frozen of chilled jiaozis of claim 1, wherein said batter comprises said one or more oil in an amount of 10 to 30 wt. %, based on the total weight of said batter.

6. The frozen of chilled jiaozis of claim 1, wherein said batter comprises said one or more oil in an amount of 15 to 25 wt. %, based on the total weight of said batter.

7. The frozen of chilled jiaozis of claim 1, wherein said batter comprises one or more oils selected from the group consisting of rapeseed oil, soybean oil, corn oil, safflower oil, palm oil, lard, shortening, butter, sesame oil, olive oil, and mixtures thereof.

8. The frozen of chilled jiaozis of claim 1, wherein said batter comprises said one or more emulsifier in an amount of 1 to 4 wt. %, based on the total weight of said batter.

9. The frozen of chilled jiaozis of claim 1, wherein said batter comprises said one or more emulsifier in an amount of 1 to 3 wt. %, based on the total weight of said batter.

10. The frozen of chilled jiaozis of claim 1, wherein said batter comprises one or more emulsifiers selected from the group consisting of a lecithin, an enzyme-digested lecithin, a sugar ester, a monoglyceride, a polyglycerol fatty acid ester, a propylene glycol fatty acid esters, and mixtures thereof.

11. The frozen of chilled jiaozis of claim 1, wherein said batter comprises said one or more starch in an amount of 6.5 to 8.5 wt. %, based on the total weight of said batter.

12. The frozen of chilled jiaozis of claim 1, wherein said batter comprises one or more starch starches selected from the group consisting of rice starch, waxy rice starch, wheat starch, corn starch, waxy corn starch, tapioca starch, sago palm starch, mung bean starch, potato starch, sweet potato starch, and mixtures thereof.

13. The frozen of chilled jiaozis of claim 1, wherein said batter comprises said one or more protein in an amount of 0.2 to 0.6 wt. %, based on the total weight of said batter.

14. The frozen of chilled jiaozis of claim 1, wherein said batter comprises one or more proteins selected from the group consisting of egg albumen powder, separated soybean protein, powdered skimmed milk, powdery wheat protein, whole egg powder, and mixtures thereof.

15. The frozen of chilled jiaozis of claim 1, wherein said batter comprises egg albumen powder.

16. A method for making frozen or chilled jiaozis, wherein said jiaozis have a surface which is already fried or to be fried and are linked with a batter, and said batter is an emulsified batter, said method comprising:
(1) forming an emulsified batter, wherein said batter comprises:
(a) 50 to 80 wt. %, based on the total weight of said batter, of water;
(b) 5 to 30 wt. %, based on the total weight of said batter, of one or more oils;
(c) 0.6 to 8 wt. %, based on the total weight of said batter, of one or more emulsifiers;
(d) 6 to 10 wt. %, based on the total weight of said batter, of one or more starches; and
(e) 0.1 to 0.7 wt. %, based on the total weight of said batter, of one or more proteins,
provided said batter is substantially free of cereal flour;
(2) arranging said two or more jiaozis in a tray with an inner, upward-facing, bottom surface such that said surface which is already fried or to be fried of said two or more jiaozis is positioned downward toward said inner, upward-facing, bottom surface of said tray; and
(3) arranging a layer of said batter on said inner, upward-facing, bottom surface between said two or more jiaozis such that said two or more jiaozis are linked by said batter.

17. The method of claim 16, wherein said layer of said batter has an average thickness of from 1 mm to less than half of the height of said jiaozi.

18. The method of claim 16, wherein said layer of said batter and said two or more jiaozis are arranged in said tray after providing said two or more jiaozi with a surface which has already been fried.

19. The method of claim 18, wherein said batter comprises:
(a) 65 to 77 wt. %, based on the total weight of said batter, of water;
(b) 10 to 30 wt. %, based on the total weight of said batter, of one or more oils;
(c) 1 to 4 wt. %, based on the total weight of said batter, of one or more emulsifiers;
(d) 6.5 to 8.5 wt. %, based on the total weight of said batter, of one or more starches; and
(e) 0.2 to 0.6 wt. %, based on the total weight of said batter, of one or more proteins.

20. The method of claim 16, wherein said batter comprises:
one or more oils selected from the group consisting of rapeseed oil, soybean oil, corn oil, safflower oil, palm oil, lard, shortening, butter, sesame oil, olive oil, and mixtures thereof;
one or more emulsifiers selected from the group consisting of a lecithin, an enzyme-digested lecithin, a sugar ester, a monoglyceride, a polyglycerol fatty acid ester, a propylene glycol fatty acid esters, and mixtures thereof;
one or more starch starches selected from the group consisting of rice starch, waxy rice starch, wheat starch, corn starch, waxy corn starch, tapioca starch, sago palm starch, mung bean starch, potato starch, sweet potato starch, and mixtures thereof; and
one or more proteins selected from the group consisting of egg albumen powder, separated soybean protein, powdered skimmed milk, powdery wheat protein, whole egg powder, and mixtures thereof.
